(19) United States
(12) Patent Application Publication
(10) Pub. No.: US 2009/0019471 A1
(43) Pub. Date: Jan. 15, 2009

(54) Personalized commercial cache

(75) Inventors: Peter Rabinovitch, Ottawa (CA); John Jordan, Ottawa (CA)

Correspondence Address: KRAMER & AMADO, P.C., 1725 DUKE STREET, SUITE 240, ALEXANDRIA, VA, 22314, US

(73) Assignee: ALCATEL LUCENT, Paris (FR)

(21) Appl. No.: 11/826,258

(22) Filed: Jul. 13, 2007

(51) Int. Cl. H04N 7/10

(52) U.S. Cl. 725/34

(57) ABSTRACT

A method and system of personalized commercial cache, including one or more of the following: obtaining personalized consumer information; identifying commercials corresponding to the obtained personalized consumer information; downloading personalized commercials that are the commercials corresponding to the personalized consumer information; storing the downloaded personalized commercials; and playing the stored personalized commercials by splicing the stored personalized commercials into a television program at a predetermined time in the television program.

### BACKGROUND OF THE INVENTION

1. Field of the Invention

This invention relates generally to the presentation of commercials in television programs.

2. Description of Related Art

The presentation of commercial advertisements during television programs is well known. However, despite efforts to select advertisements during television programs likely to be interesting to a typical viewer of that television program, nevertheless, viewers of television programs are often presented with advertisements for products they do not find interesting. Thus, there is a need for the presentation of commercials in television programs that are personalized to a particular viewer of the television program.

The foregoing objects and advantages of the invention are illustrative of those that can be achieved by the various exemplary embodiments and are not intended to be exhaustive or limiting of the possible advantages which can be realized. Thus, these and other objects and advantages of the various exemplary embodiments will be apparent from the description herein or can be learned from practicing the various exemplary embodiments, both as embodied herein or as modified in view of any variation which may be apparent to those skilled in the art. Accordingly, the present invention resides in the novel methods, arrangements, combinations and improvements herein shown and described in various exemplary embodiments.

### SUMMARY OF THE INVENTION

In light of the present need for personalized commercials in television programs, a brief summary of various exemplary embodiments is presented. Some simplifications and omission may be made in the following summary, which is intended to highlight and introduce some aspects of the various exemplary embodiments, but not to limit its scope. Detailed descriptions of a preferred exemplary embodiment adequate to allow those of ordinary skill in the art to make and use the invention concepts will follow in later sections.

Various exemplary embodiments are a method of personalized commercial cache, including one or more of the following: obtaining personalized consumer information; identifying commercials corresponding to the obtained personalized consumer information; downloading personalized commercials that are the commercials corresponding to the personalized consumer information; storing the downloaded personalized commercials; and playing the stored personalized commercials by splicing the stored personalized commercials into a television program at a predetermined time in the television program.

In various exemplary embodiments, downloading the personalized commercials occurs overnight. In various exemplary embodiments the downloaded personalized commercials are played the next day. In various exemplary embodiments the personalized commercials are downloaded every night.

In various exemplary embodiments the personalized consumer information includes geographic information regarding the consumer. In various exemplary embodiments the personalized consumer information includes a zip code of the consumer.

In various exemplary embodiments the personalized consumer information is obtained using a survey. In various exemplary embodiments the personalized consumer information is obtained by data analysis. In various exemplary embodiments the data analysis includes logging data regarding channel changing information. In various exemplary embodiments the personalized consumer information obtained includes a log of commercials during which the channel is changed and a log of commercials during which the channel is not changed.

In various exemplary embodiments, downloading personalized commercials includes downloading indicators that indicate when the commercials are to be played. In various exemplary embodiments the indicators are selected from the group consisting of anytime, a time when the commercial must be played, and a time when the commercial must not be played.

Various exemplary embodiments include playing commercials that are not personalized. In various exemplary embodiments the non-personalized commercials are included in the television program.

In various exemplary embodiments the personalized consumer information obtained includes a potential value of directly targeting the consumer. Various exemplary embodiments include evaluating whether the potential value of directly targeting the consumer exceeds a predetermined threshold.

Various exemplary embodiments are a system for personalized commercial cache, including one or more of the following: a commercial cache; a communications network for transmitting commercials selected from the commercial cache; a set top box that receives commercials communicated from the commercial cache through the commercial network; a means of obtaining personalized consumer information; a means of identifying personalized commercials corresponding to the obtained personalized consumer information; a means of downloading the identified personalized commercials from the commercial cache to the set top box through the communications network; a means of storing the personalized commercials on the set top box; and a means of playing the personalized commercials during a broadcast of a television program.

### BRIEF DESCRIPTION OF THE DRAWINGS

In order to better understand various exemplary embodiments, reference is made to the accompanying drawings, wherein:

FIG. 1 is a schematic drawing depicting an exemplary system for a personalized commercial cache; and

FIG. 2 is a flowchart depicting an exemplary embodiment of a method for a personalized commercial cache.

### DETAILED DESCRIPTION OF THE PREFERRED EMBODIMENTS OF THE INVENTION

End users who watch television programs are often uninterested in the goods or services advertised in commercials during commercial breaks in the television program being viewed by the end user. The subject matter described herein is directed at presenting end users who view television programs with commercials that are targeted to the interests of each particular end user.

One problem with a system and method that provides unique and distinct sets of targeted commercials for each end user is that such systems and methods place a larger burden on a system for broadcasting a television program than a system or method wherein each end user viewing the television program sees the same set of commercials. In various exemplary embodiments, the foregoing problem of scalability is addressed by transmitting commercials intended to be broadcast with a television program at a time in advance of the television program.

In various exemplary embodiments, targeted sets of commercials are transmitted during off-peak hours. Thus, in various exemplary embodiments, targeted commercials are transmitted in the middle of the night. In various exemplary embodiments, targeted commercials are transmitted in the middle of the night every night and are played out during television programs the following day.

In the United States, over sixty billion dollars a year is spent on television advertising. Typically, television advertisements are segmented into extremely large groups. For example, television advertisements are segmented in various exemplary embodiments into segments whereby an entire metropolitan city receives the same set of advertisements for every television viewer in that city.

The subject matter described herein improves upon the approach described above in that advertisements viewed by an end user are more closely aligned with the interests and demographics of that end user, for example. In an embodiment where every end user of a television program receives a unique set of commercials that are broadcast in real time to each end user along with the television program being viewed, significant burdens are placed upon the transmission capabilities of the television program communication system and network.

Referring now to the drawings, in which like numerals refer to like components or steps, there are disclosed broad aspects of various exemplary embodiments.

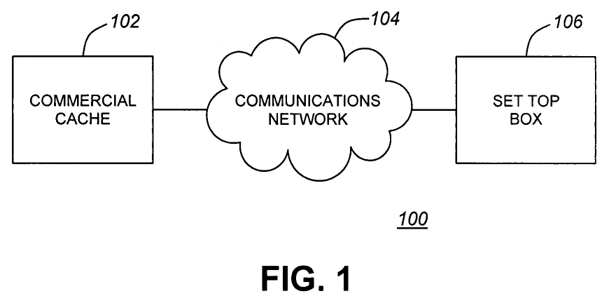

FIG. 1 depicts an exemplary system 100 for a personalized commercial cache. The exemplary system 100 includes a commercial cache 102, a communications network 104 and a set top box 106.

The set top box 106 represents any means of storage local to an end user viewing a television program. Thus, in various exemplary embodiments, the set top box 106 is a device physically separate from the end user's television. In other exemplary embodiments, the set top box is physically contained within the same enclosure that contains the end user's television.

In still other exemplary embodiments, the set top box is included in the same enclosure as an end user's computer processor. Similarly, in other exemplary embodiments, any currently known or later developed storage device used in connection with playing a television program for an end user is included.

The communications network 104 is, in various exemplary embodiments, a television network wherein television programs are communicated to the set top box 106 and the end user's television. It should be apparent that the communications network 104 is any known or later developed system wherein television programs are communicated to an end user.

The commercial cache 102 is a cache of a plurality of commercials. As will be discussed in greater detail below, the commercial cache 102 is a repository from which personalized commercials are selected for each individual end user.

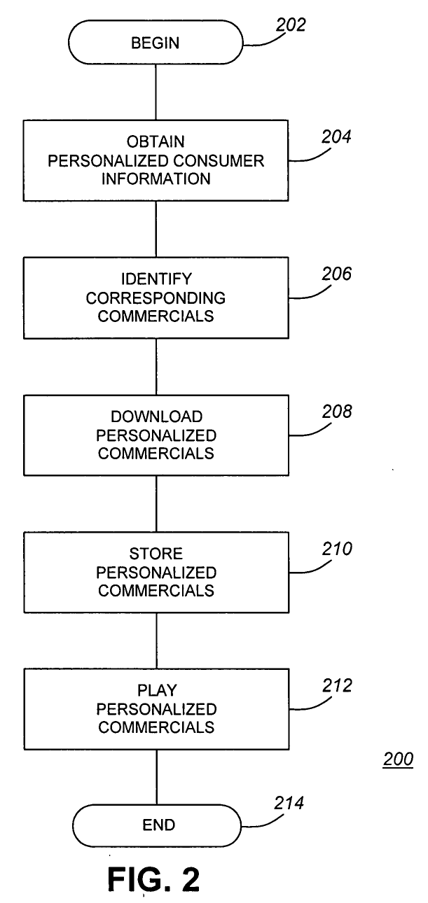

FIG. 2 is an exemplary flowchart 200 of an exemplary method for personalized commercial cache. The method 200 begins in step 202 and then proceeds to step 204.

In step 204 personalized consumer information is obtained about the end user viewing a television program. The personalized consumer information obtained in step 204 is information that indicates which commercials the end user is most likely to respond to.

In various exemplary embodiments, the personalized consumer information is obtained in step 204 through the use of one or more surveys. In various exemplary embodiments, the personalized consumer information obtained in step 204 is obtained based on demographic information linked to a geographical area. Thus, in some exemplary embodiments, the personalized consumer information obtained in step 204 is obtained from personal information already on record regarding each individual end user.

For example, in some exemplary embodiments, personalized information regarding each end user is stored by a television service provider for that end user. In various exemplary embodiments, this personalized information regarding the end user includes the end user's zip code. Thus, in various exemplary embodiments, personalized consumer information regarding the end users is obtained in step 204 by accessing a postal zip code on file with the end user's television service provider.

In various exemplary embodiments, personalized consumer information is obtained is step 204 using any known, or later developed, data analysis technique. Thus, for example, in various exemplary embodiments, channel change information is compiled for each end user.

In various exemplary embodiments, channel change information compiled for each end user is used to correlate which commercials each end user watches and which commercials that end user skips. In various exemplary embodiments, analyzing information such as, for example, the information of channel change data described above, is used to obtain personalized consumer information in step 204.

Upon obtaining personalized consumer information in step 204, the method 200 proceeds to step 206. In step 206, commercials corresponding to the personalized consumer information obtained in step 204 are identified. In various exemplary embodiments, the pool of commercials from which corresponding commercials are identified in step 206 is the pool of commercials stored in commercial cache 102.

In various exemplary embodiments, a criteria used to identify corresponding commercials in step 206 includes the commercials believed to generate the highest possible revenue for the advertiser of the commercials. Following an identification of corresponding commercials in step 206, the method 200 proceeds to step 208.

In step 208, the personalized commercials identified in step 206 are downloaded to the end user's set top box 106. In various exemplary embodiments, the personalized commercials are downloaded in step 208 during off-peak hours for broadcasting television programs. Thus, in various exemplary embodiments, the personalized commercials are downloaded in step 208 in the middle of the night.

In various exemplary embodiments, the downloading of personalized commercials in step 208 also includes downloading an indicator of when each commercial should be played. For example, indicators of when a particular commercial may be played include, but are not limited to, examples such as the following: anytime; a time when the commercial must be played; and a time when the commercial must not be played.

An example of an indicator of when a commercial must be played is, for example, the first commercial break after 9 PM. An example of an indicator when a commercial must not be played is, for example, when a commercial must not be played before 8 PM. Thus, an indicator such as an indicator when a commercial must not be played, is used, in various exemplary embodiments, to prevent small children from viewing a commercial with content deemed not to be suitable for small children.

Following step 208, in step 210, the personalized commercials that are downloaded in step 208 are stored. In various exemplary embodiments, the personalized commercials are stored in step 210 at the end user's set top box 106. Following step 210, the method 200 proceeds to step 212.

In step 212, the personalized commercials that were stored in step 210 are played on the end user's television. In various exemplary embodiments, the personalized commercials are played the day they are downloaded.

In various exemplary embodiments, the personalized commercials are played in response to a place holding indicator in a television program indicating that it is time to play commercials. In various exemplary embodiments, commercials from the downloaded personalized set of commercials are chosen and spliced into the video stream of a television program according to indicators in the commercials and business logic.

In various exemplary embodiments, one or more commercials included in the television broadcast are included in the set of commercials viewed by the end user during a viewing of the television program. For example, if the personalized commercials downloaded in step 208 are fewer in volume than the total volume of commercials needed, in some exemplary embodiments, one or more original commercials in the television program are viewed by the end user. In other exemplary embodiments, when the volume of personalized commercials downloaded in step 208 is smaller than the volume of commercials needed, one or more of the personalized commercials downloaded in step 208 are repeated.

In various exemplary embodiments, the scheme described above is adjusted for providers who are unable to follow any of the various exemplary embodiments described above due to bandwidth or other scalability constraints. Thus, in various exemplary embodiments, the personalized consumer information obtained in step 204 includes an identification of consumers having the highest potential value for targeting with personalized commercials. Correspondingly, in various exemplary embodiments, the method 200 is implemented only for consumers identified in step 204 as having the highest potential value to directly target with the other steps of the method 200.

Based on the foregoing, various exemplary embodiments overcome problems with scale that exist with other systems and methods for customized commercial distribution. Thus, the subject matter described herein has a potentially tremendous value for the providers of television programming. This is true for at least the reason that various exemplary embodiments described herein enable more directed targeting of advertising dollars.

Although the various exemplary embodiments have been described in detail with particular reference to certain exemplary aspects thereof, it should be understood that the invention is capable of other different embodiments, and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only, and do not in any way limit the invention, which is defined only by the claims.

What is claimed is:

1. A method of personalized commercial cache, comprising:
obtaining personalized consumer information;
identifying commercials corresponding to the obtained personalized consumer information;
downloading personalized commercials that are the commercials corresponding to the personalized consumer information;
storing the downloaded personalized commercials; and
playing the stored personalized commercials by splicing the stored personalized commercials into a television program at a predetermined time in the television program.

2. The method of personalized commercial cache, according to claim 1, wherein downloading the personalized commercials occurs overnight.

3. The method of personalized commercial cache, according to claim 2, wherein the downloaded personalized commercials are played the next day.

4. The method of personalized commercial cache, according to claim 3, wherein the personalized commercials are downloaded every night.

5. The method of personalized commercial cache, according to claim 1, wherein the personalized consumer information includes geographic information regarding the consumer.

6. The method of personalized commercial cache, according to claim 5, wherein the personalized consumer information includes a zip code of the consumer.

7. The method of personalized commercial cache, according to claim 1, wherein the personalized consumer information is obtained using a survey.

8. The method of personalized cache, according to claim 1, wherein the personalized consumer information is obtained by data analysis.

9. The method of personalized commercial cache, according to claim 8, wherein the data analysis includes logging data regarding channel changing information.

10. The personalized commercial cache, according to claim 9, wherein the personalized consumer information obtained includes a log of commercials during which the channel is changed and a log of commercials during which the channel is not changed.

11. The method of personalized commercial cache, according to claim 1, wherein downloading personalized commercials includes downloading indicators that indicate when the commercials are to be played.

12. The method of personalized commercial cache, according to claim 11, wherein the indicators are selected from the group consisting of anytime, a time when the commercial must be played, and a time when the commercial must not be played.

13. The method of personalized commercial cache, according to claim 1, further comprising playing commercials that are non-personalized.

14. The method of personalized commercial cache, according to claim 13, wherein the non-personalized commercials are included in the television program.

15. The method of personalized commercial cache, according to claim 1, wherein the personalized consumer information obtained includes a potential value of directly targeting the consumer.

16. The method of personalized commercial cache, according to claim 15, further comprising evaluating whether the potential value of directly targeting the consumer exceeds a predetermined threshold.

17. A system for personalized commercial cache, comprising:
a commercial cache;
a communications network for transmitting commercials selected from the commercial cache;
a set top box that receives commercials communicated from the commercial cache through the commercial network;
a means of obtaining personalized consumer information;
a means of identifying personalized commercials corresponding to the obtained personalized consumer information;
a means of downloading the identified personalized commercials from the commercial cache to the set top box through the communications network;
a means of storing the personalized commercials on the set top box; and
a means of playing the personalized commercials during a broadcast of a television program.
